(19) United States
(12) Patent Application Publication
(10) Pub. No.: US 2012/0218937 A1
(43) Pub. Date: Aug. 30, 2012

(54) User Equipment Feedback In Support of Multiple Input Multiple Output Operations

(75) Inventors: Runhua Chen, Dallas, TX (US); Eko N. Onggosanusi, Allen, TX (US)

(73) Assignee: TEXAS INSTRUMENTS INCORPORATED, Dallas, TX (US)

(21) Appl. No.: 12/766,151

(22) Filed: Apr. 23, 2010

Related U.S. Application Data
(60) Provisional application No. 61/172,008, filed on Apr. 23, 2009.

(51) Int. Cl. H04W 4/00

(52) U.S. Cl. 370/328

(57) ABSTRACT

A method of feedback in wireless telephony includes a hybrid of implicit and explicit feedback. The implicit and explicit feedback are transmitted in distinct subframes. These distinct set of subframes may have the same periodicity but differing offsets. The distinct set of subframes may have periodicities related by an integral factor. Either set of subframes may include aperiodic subframes.

### CLAIM OF PRIORITY

This application claims priority under 35 U.S.C. 119(e)(1) to U.S. Provisional Application No. 61/172,008 filed Apr. 23, 2009.

### TECHNICAL FIELD OF THE INVENTION

The technical field of this invention is wireless telephone communication.

### BACKGROUND OF THE INVENTION

FIG. 1 shows an exemplary wireless telecommunications network 100. The illustrative telecommunications network includes base stations 101, 102 and 103, though in operation, a telecommunications network necessarily includes many more base stations. Each of base stations 101, 102 and 103 are operable over corresponding coverage areas 104, 105 and 106. Each base station's coverage area is further divided into cells. In the illustrated network, each base station's coverage area is divided into three cells. Handset or other user equipment (UE) 109 is shown in Cell A 108. Cell A 108 is within coverage area 104 of base station 101. Base station 101 transmits to and receives transmissions from UE 109. As UE 109 moves out of Cell A 108 and into Cell B 107, UE 109 may be handed over to base station 102. Because UE 109 is synchronized with base station 101, UE 109 can employ non-synchronized random access to initiate handover to base station 102.

Non-synchronized UE 109 also employs non-synchronous random access to request allocation of up link 111 time or frequency or code resources. If UE 109 has data ready for transmission, which may be traffic data, measurements report, tracking area update, UE 109 can transmit a random access signal on up link 111. The random access signal notifies base station 101 that UE 109 requires up link resources to transmit the UEs data. Base station 101 responds by transmitting to UE 109 via down link 110, a message containing the parameters of the resources allocated for UE 109 up link transmission along with a possible timing error correction. After receiving the resource allocation and a possible timing advance message transmitted on down link 110 by base station 101, UE 109 optionally adjusts its transmit timing and transmits the data on up link 111 employing the allotted resources during the prescribed time interval.

The current Evolved Universal Terrestrial Radio Access (E-UTRA) Long Term Evolution (LTE) Advanced (Release-10) standard aims to achieve three to four times higher data rate and spectral efficiency than a prior standard. Advanced downlink (DL) multiple input, multiple output (MIMO) transmission schemes are believed necessary in order to achieve this. Higher order MIMO with up to 8 transmission antenna will be supported in downlink. Thus up to 8 spatial layers can be transmitted. This increases cell average and cell-edge performance compared to the two or four transmission antenna for DL MIMO in the prior standard.

Coordinated Multiple Point transmission (CoMP) has been proposed. In conventional cellular networks a single UE receives data transmission from a single eNB at a time. In CoMP multiple eNBs may coordinately make downlink transmission to a UE simultaneously. CoMP extends the conventional “single cell-multiple UEs” system structure to a “multiple cells-multiple UEs” network topology. The concept of cell edge UE gives way to that of a UE in the vicinity of cell boundaries being at the center area of a “super-cell” consisting multiple cells. UEs in CoMP communication mode will get much better service and boosted signal to noise ratio (SNR) if several nearby cells work in cooperation or coordination. Such involved cells are called CoMP cells.

Channel feedback is critical for reaping the close-loop MIMO transmission gain. In channel feedback the UE feeds back information of measured downlink channel to eNB in either uplink control or uplink data channel. This information enables the eNB to determine the downlink transmission scheme, perform MIMO precoding, conduct frequency/time scheduling assignment and perform UE paring in multiuser-MIMO mode.

In the prior standard UE feedback is in the recommended MIMO transmission format, such as rank indication, precoding matrix indicator and channel quality indicator. The UE feeds back a set of preferred rank indicator/precoding matrix indicator/channel quality indicator (RI/PMI/CQI) data which is a recommendation for eNB downlink transmission. The eNB may use UE feedback to perform downlink precoding and scheduling.

In the current standard advanced UE feedback is necessary to enable 8 transmitter antenna MIMO and CoMP transmission. There are three types of such feedback in the current standard:

1. Explicit channel state/statistical information feedback, where the channel is observed by the receiver. This should be both without assuming any transmission or receiver processing and including at least part of the receiver processing;

2. Implicit channel state/statistical information feedback including recommended transmission properties, such as CQI/PMI/RI, as in the prior standard; and

3. UE transmission of sounding reference signal (SRS) can be used for channel state information (CSI) estimation at eNB exploiting channel reciprocity.

Both explicit and implicit channel feedback could be obtained by using CSI reference signal (CSI-RS) transmitted from eNB in the downlink. Besides reusing the cell-specific RS (CRS) in the prior standard as CSI-RS, it is possible to implement a new set of CSI-RS for the new standard or use a combination of previous and new CSI-RS. This CSI-RS may be transmitted in a low duty cycle, such as once every N subframes, where N≧1, because the new standard is intended for low-mobility and local area setup.

### SUMMARY OF THE INVENTION

A method of feedback in wireless telephony includes a hybrid of implicit and explicit feedback. The implicit and explicit feedback are transmitted in distinct subframes. These distinct set of subframes may have the same periodicity but differing offsets. The distinct set of subframes may have periodicities related by an integral factor. Either set of subframes may include aperiodic subframes.

### BRIEF DESCRIPTION OF THE DRAWINGS

These and other aspects of this invention are illustrated in the drawings, in which:

FIG. 1 is a diagram of a communication system of the prior art related to this invention having three cells; and

FIG. 2 is a subframe timing diagram showing explicit and implicit sets of subframes having the same periodicity and differing offsets;

FIG. 3 is a subframe timing diagram showing explicit and implicit sets of subframes having periodicities which are integral multiples; and

FIG. 4 is a subframe timing diagram showing explicit and implicit sets of subframes including an example aperiodic subframe.

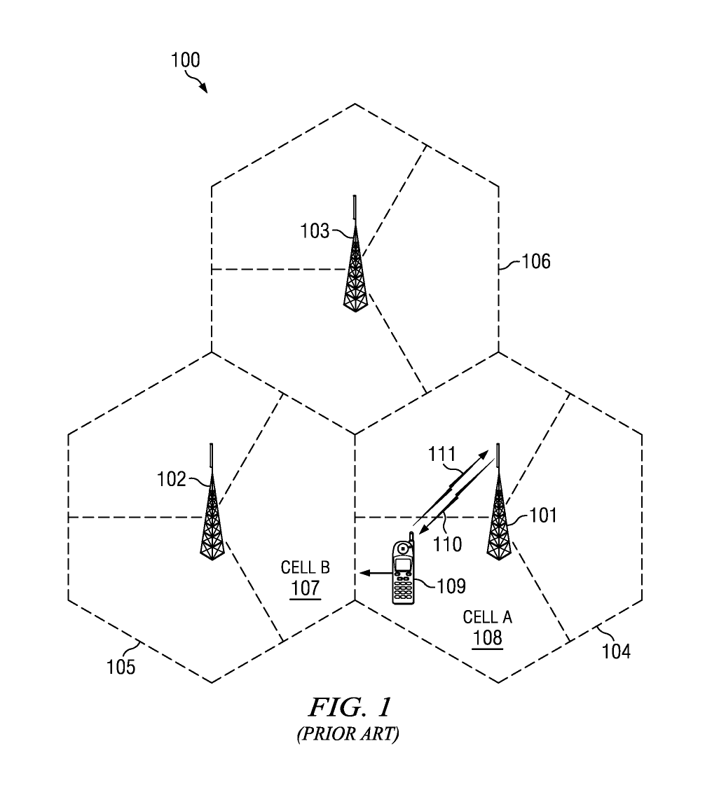

### DETAILED DESCRIPTION OF PREFERRED EMBODIMENTS

The feedback may include explicit channel state/statistical information feedback. Such explicit channel feed back includes the channel observed by the receiver without assuming any transmission or receiver processing.

By definition explicit channel feedback reports the directly measured channel to the eNB. Since the eNB has direction information of the corresponding downlink channel, the eNB may perform non-codebook based MIMO precoding or perform joint processing CoMP across multiple eNBs. This later option assumes a fast and reliable X2 interface is available. The eNB thus has the most flexibility in downlink transmission/scheduling, and implement a more refined MIMO precoding compared to codebook based precoding and can achieve higher DL throughput at the expense of the highest overhead. Alternatives to reduce the channel feedback overhead include reporting the transmit/receive covariance matrix instead of the instantaneous channel realization.

The feedback may include implicit channel state/statistical information feedback on the channel observed by the receiver, including at least a part of the receiver processing. Such implicit channel feedback recommends the transmission properties such as CQI/PMI/RI as known in the prior standard. This implicit channel state information contains the recommended transmission format at a much lower feedback overhead than explicit feedback. Processing is more UE-centric and testing of UE feedback is relatively easy. However such implicit channel station information may not enable the maximum downlink throughput gain in complicated downlink MIMO schemes, such as multiuser MIMO and CoMP joint processing.

In light of the pros and cons of these two feedback categories, this invention is a hybrid explicit/implicit feedback scheme. The UE can supply feedback by a combination of (hybrid) explicit/implicit feedback information to the eNB.

The explicit channel feedback may be used by eNB to initiate the downlink transmission, such as: UE paring in MU-MIMO; to derive the intercell coordinated beamforming vectors to reduce co-channel interference and boost the SNR of cell-edge users; and to derive a long-term beamforming setup at the base station. This explicit channel feedback may contain long-term channel statistics as the covariance.

On the other hand, implicit channel feedback of CQI/PMI/RI could be reported more frequently to report channel information that changes faster. This fast changing information includes the SNR value after UE processing, the recommended modulation and coding scheme (MCS) and the recommended RI/PMI for the next couple of subframes.

Multiplexing explicit and implicit feedback may follow a time division multiplexing (TDM) scheme where a particular feedback instance (subframe) reports explicit channel feedback and another feedback instance (subframe) reports implicit channel feedback. Frequency division multiplexing (FDM) and code division multiplexing (CDM) are also feasible form multiplexing explicit/implicit feedback, where explicit/implicit channel information are reported in the same subframe but on orthogonal frequency resources or on orthogonal spreading sequences. The periodicity/cycle/offset of explicit and implicit feedback may be configured by the network and may be different.

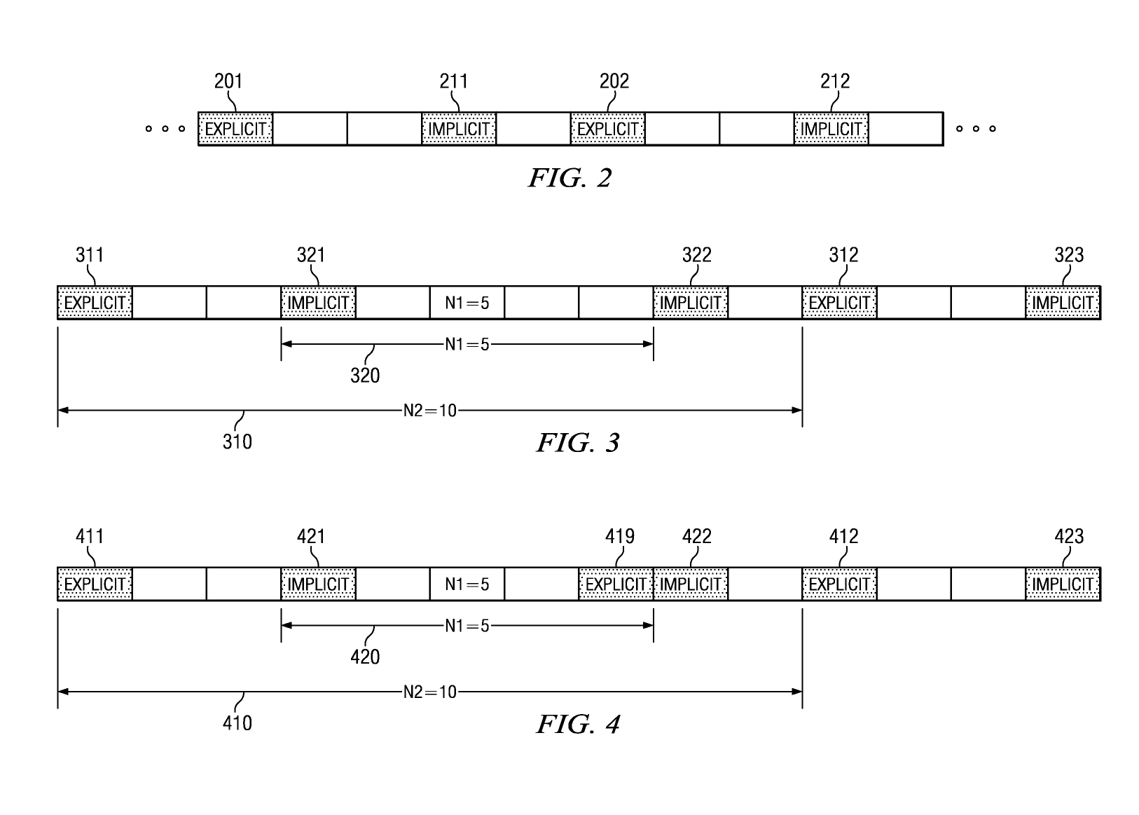

FIG. 2 illustrates a first example of hybrid explicit/implicit feedback. Both explicit and implicit channel feedback have a periodicity of 5 subframes. Explicit feedback occupies subframes 201 and 203. Implicit feedback occupies subframes 202 and 204. FIG. 2 illustrates different reporting offsets so that explicit feedback and implicit feedback will not collide with each other.

FIG. 3 illustrates a second example of hybrid explicit/implicit feedback. The feedback periodicity of explicit and implicit feedback is different than in the example illustrated in FIG. 2. In this example, explicit feedback which has a higher feedback overhead/accuracy is configured with a feedback periodicity of N2 310 of once per ten subframes between explicit feedback subframes 311 and 312. Implicit feedback which has less overhead is configured another feedback periodicity of N1 320 between implicit subframes 321, 322 and 323 of once per five subframes. In this example N2≧N1.

The feedback periodicity of explicit feedback may be a multiple integer of that of the implicit feedback. Thus:

N2=M*N1,

where: M is a positive integer number greater than or equal to 1. FIG. 3 illustrates an example where M is 2. This pattern ensures no collision between regularly scheduled explicit and implicit feedback.

FIG. 4 illustrates a third example of hybrid explicit/implicit feedback. FIG. 4 includes a periodic explicit/implicit feedback pattern with an aperiodic trigger of an explicit or implicit report by scheduling a dynamic grant. In this example, explicit feedback has a feedback periodicity of N2 410 of once per ten subframes between explicit feedback subframes 411 and 412. Implicit feedback which has less overhead has a feedback periodicity of N1 420 between implicit subframes 421, 422 and 423 of once per five subframes. FIG. 4 also illustrates an aperiodic explicit feedback subframe 419. Such an aperiodic subframe may be triggered for both explicit and implicit feedback at any time the eNB deem necessary.

What is claimed is:

1. A method of wireless telephony including transmitting feedback control information from a user equipment to at least one base station comprising the steps of:
transmitting data in a series of sequential subframes;
transmitting implicit feedback in a first set of subframes, the implicit feedback including data of a channel observed by receiver assuming including at least a part of the receiver processing; and
transmitting explicit feedback in a second set of subframes distinct from said first set of subframes, the explicit feedback including data of a channel observed by receiver without assuming transmission or receiver processing.

2. The method of claim 1, wherein:
said first set of subframes are subframes having a first periodicity and a first offset; and
said second set of subframes are subframes having said first periodicity and a second offset different from said first offset.

3. The method of claim 1, wherein:
said first set of subframes are subframes having a first periodicity and a first offset; and
said second set of subframes are subframes having a second periodicity different from said first periodicity and a second offset different from said first offset.

4. The method of claim 3, wherein:
said first periodicity is once per N1 subframes, where N1 is an integer;
said second periodicity is once per N2 subframes, where N2=M*N1 and M is a positive integer.

5. The method of claim 3, wherein:
said first set of subframes further includes at least one aperiodic subframe.

6. The method of claim 3, wherein:
said second set of subframes further includes at least one aperiodic subframe.
